(19) United States
(12) Patent Application Publication
(10) Pub. No.: US 2024/0220892 A1
(43) Pub. Date: Jul. 4, 2024

(54) DIGITAL PROCESSING SYSTEMS AND METHODS FOR PERFORMING DYNAMIC TICKET ASSIGNMENT OPERATIONS BASED ON CONTINUOUSLY CHANGING INPUT AND OUTPUT PARAMETERS

(71) Applicant: Monday.com LTD., Tel Aviv (IL)

(72) Inventors: Jonathan Farache, Tel Aviv (IL); Chezki Botwinick, Tel Aviv (IL)

(73) Assignee: Monday.com LTD., Tel Aviv (IL)

(21) Appl. No.: 18/148,817

(22) Filed: Dec. 30, 2022

(51) Int. Cl. G06Q 10/0631

(52) U.S. Cl. CPC G06Q 10/06316; G06Q 10/06311

(57) ABSTRACT

Systems, methods, and computer-readable media for performing dynamic ticket assignments based on continuously changing input and output parameters are disclosed. The systems and methods involve initially receiving a first plurality of ticket requests and receiving resource information about a plurality of available resources. During a first time window, disclosed embodiments determine a first plurality of preferred matches and assign the first plurality of ticket requests. Systems and methods subsequently receive a second plurality of ticket requests. During a second time window, disclosed embodiments determine a second plurality of preferred matches and assign the second plurality of ticket requests. Systems and methods receive updates of ticket factor information and resource information and update ticket requests and resource information. During a third time window, disclosed embodiments determine a third plurality of preferred matches and assign at least one of the first ticket requests, second ticket requests, or the updated ticket requests.

### TECHNICAL FIELD

The present disclosure relates to systems, methods, and computer readable media for optimizing computer systems that perform dynamic ticket assignment. For example, disclosed embodiments may be configured to perform dynamic ticket assignment operations based on continuous changing input and output parameters.

### BACKGROUND

Operation of modern enterprises can be complicated and time consuming. In many cases, managing the operation of a single project requires integration of several employees, departments, and other resources of the entity. To manage the challenging operation, project management software applications may be used. Such software applications allow a user to organize, plan, and manage resources by providing project-related information to optimize the time and resources spent on each project. However, traditional systems suffer from inefficiencies resulting from performing excessive and redundant iterations of project assignment algorithms. Improvements to these software applications are desired to increase operational and computer resource efficiency.

### SUMMARY

Embodiments consistent with the present disclosure provide systems, methods, and computer readable media generally relating to ticket assignment operations. The disclosed systems and methods may be implemented using a combination of conventional hardware and software as well as specialized hardware and software, such as a machine constructed and/or programmed specifically for performing functions associated with the disclosed method steps. Consistent with other disclosed embodiments, non-transitory computer readable storage media may store program instructions, which are executed by at least one processing device and perform any of the steps and/or methods described herein.

Consistent with disclosed embodiments, systems, methods, and computer readable media for performing dynamic ticket operations based on continuous changing input and output parameters are disclosed. The embodiments may include at least one processor. The at least one processor may be configured to initially receive in a backlog data structure from a plurality of different sources, a first plurality of ticket requests. Each of the first plurality of ticket requests may include first ticket factor information. The first ticket factor information may include a first priority factor, a first skill factor, a first language indicator, and a first response time factor. The at least one processor may also be configured to receive in a resource availability data structure, resource information about a plurality of available resources. The resource information for each of the plurality of resources may include resource language information, resource schedule information, resource capacity information, and resource skill information. During a first time window following initial receipt of the first plurality of ticket requests, the at least one processor may be configured to determine a first plurality of preferred matches between the first plurality of ticket requests and the plurality of available resources. The at least one processor may also be configured to assign the first plurality of ticket requests based on the first plurality of preferred matches.

The at least one processor may further be configured to subsequently receive in the backlog data structure, a second plurality of ticket requests. The second plurality of ticket requests may include second ticket factor information. The second ticket factor information may include a second priority factor, a second skill factor, a second language indicator, and a second response time factor. During a second time window following subsequent receipt of the second plurality of ticket requests, the at least one processor may be configured to determine a second plurality of preferred matches between the second plurality of ticket requests and the plurality of available resources. The at least one processor may also be configured to assign the second plurality of ticket requests based on the second plurality of preferred matches.

The at least one processor may further be configured to receive in the backlog data structure, updates of ticket factor information for some of the received first and second pluralities of ticket requests. And the at least one processor may be configured to update ticket requests based on the received updates. During a third time window following the second time window, the at least one processor may be configured to determine a third plurality of preferred matches between: at least one of the first ticket requests, the second ticket requests, or the updated ticket requests; and at least one of the available resources or the updated available resources. The at least one processor may also be configured to assign at least one of the first ticket requests, second ticket requests, or the updated ticket requests, based on the third plurality of preferred matches.

### BRIEF DESCRIPTION OF THE DRAWINGS

FIG. 1 is a block diagram of an exemplary computing device which may be employed in connection with embodiments of the present disclosure.

FIG. 2 is a block diagram of an exemplary computing architecture for collaborative work systems, consistent with embodiments of the present disclosure.

FIG. 3 illustrates an example of an electronic collaborative word processing document, consistent with some embodiments of the present disclosure.

FIG. 4 is an illustration of an exemplary ticket or ticket request, consistent with disclosed embodiments.

FIG. 5 is an illustration of an exemplary backlog data structure including a plurality of tickets, consistent with disclosed embodiments.

FIG. 6 illustrates an example of resource information of an available resource, consistent with disclosed embodiments.

FIG. 7 is an illustration of an exemplary resource availability data structure including a plurality of resource information associated with a plurality of available resources, consistent with disclosed embodiments.

FIG. 8 is a block diagram of an exemplary system and technique for performing dynamic ticket assignment operations based on continuously changing input and output parameters, consistent with disclosed embodiments.

FIG. 9 is a flowchart of performing dynamic ticket assignment operations, consistent with disclosed embodiments.

FIG. 10 is a flowchart of an exemplary process for dynamic ticket assignment optimization, consistent with disclosed embodiments

### DETAILED DESCRIPTION

Exemplary embodiments are described with reference to the accompanying drawings. The figures are not necessarily drawn to scale. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It should also be noted that as used herein and in the appended claims, the singular forms “a,” “an,” and “the” include plural references unless the context clearly dictates otherwise.

In the following description, various working examples are provided for illustrative purposes. However, is to be understood the present disclosure may be practiced without one or more of these details.

Throughout, this disclosure mentions “disclosed embodiments,” which refer to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic.

This disclosure presents various mechanisms for collaborative work systems. Such systems may involve software that enables multiple users to work collaboratively. By way of one example, workflow management software may enable various members of a team to cooperate via a common online platform. It is intended that one or more aspects of any mechanism may be combined with one or more aspect of any other mechanisms, and such combinations are within the scope of this disclosure.

This disclosure is constructed to provide a basic understanding of a few exemplary embodiments with the understanding that features of the exemplary embodiments may be combined with other disclosed features or may be incorporated into platforms or embodiments not described herein while still remaining within the scope of this disclosure. For convenience, and form of the word “embodiment” as used herein is intended to refer to a single embodiment or multiple embodiments of the disclosure.

Certain embodiments disclosed herein include devices, systems, and methods for collaborative work systems that may allow a user to interact with information in real time. To avoid repetition, the functionality of some embodiments is described herein solely in connection with a processor or at least one processor. It is to be understood that such exemplary descriptions of functionality apply equally to methods and computer readable media and constitutes a written description of systems, methods, and computer readable media. The underlying platform may allow a user to structure a systems, methods, or computer readable media in many ways using common building blocks, thereby permitting flexibility in constructing a product that suits desired needs. This may be accomplished through the use of boards. A board may be a table configured to contain items (e.g., individual items presented in horizontal rows) defining objects or entities that are managed in the platform (task, project, client, deal, etc.). Unless expressly noted otherwise, the terms “board” and “table” may be considered synonymous for purposes of this disclosure. In some embodiments, a board may contain information beyond which is displayed in a table. Boards may include sub-boards that may have a separate structure from a board. Sub-boards may be tables with sub-items that may be related to the items of a board. Columns intersecting with rows of items may together define cells in which data associated with each item may be maintained. Each column may have a heading or label defining an associated data type. When used herein in combination with a column, a row may be presented horizontally and a column vertically. However, in the broader generic sense as used herein, the term “row” may refer to one or more of a horizontal and/or a vertical presentation. A table or tablature as used herein, refers to data presented in horizontal and vertical rows, (e.g., horizontal rows and vertical columns) defining cells in which data is presented. Tablature may refer to any structure for presenting data in an organized manner, as previously discussed. such as cells presented in horizontal rows and vertical columns, vertical rows and horizontal columns, a tree data structure, a web chart, or any other structured representation, as explained throughout this disclosure. A cell may refer to a unit of information contained in the tablature defined by the structure of the tablature. For example, a cell may be defined as an intersection between a horizontal row with a vertical column in a tablature having rows and columns. A cell may also be defined as an intersection between a horizontal and a vertical row, or as an intersection between a horizontal and a vertical column. As a further example, a cell may be defined as a node on a web chart or a node on a tree data structure. As would be appreciated by a skilled artisan, however, the disclosed embodiments are not limited to any specific structure, but rather may be practiced in conjunction with any desired organizational arrangement. In addition, tablature may include any type of information, depending on intended use. When used in conjunction with a workflow management application, the tablature may include any information associated with one or more tasks, such as one or more status values, projects, countries, persons, teams, progress statuses, a combination thereof, or any other information related to a task.

While a table view may be one way to present and manage the data contained on a board, a table's or board's data may be presented in different ways. For example, in some embodiments, dashboards may be utilized to present or summarize data derived from one or more boards. A dashboard may be a non-table form of presenting data, using, for example, static or dynamic graphical representations. A dashboard may also include multiple non-table forms of presenting data. As discussed later in greater detail, such representations may include various forms of graphs or graphics. In some instances, dashboards (which may also be referred to more generically as “widgets”) may include tablature. Software links may interconnect one or more boards with one or more dashboards thereby enabling the dashboards to reflect data presented on the boards. This may allow, for example, data from multiple boards to be displayed and/or managed from a common location. These widgets may provide visualizations that allow a user to update data derived from one or more boards.

Boards (or the data associated with boards) may be stored in a local memory on a user device or may be stored in a local network repository. Boards may also be stored in a remote repository and may be accessed through a network. In some instances, permissions may be set to limit board access to the board's “owner” while in other embodiments a user's board may be accessed by other users through any of the networks described in this disclosure. When one user makes a change in a board, that change may be updated to the board stored in a memory or repository and may be pushed to the other user devices that access that same board. These changes may be made to cells, items, columns, boards, dashboard views, logical rules, or any other data associated with the boards. Similarly, when cells are tied together or are mirrored across multiple boards, a change in one board may cause a cascading change in the tied or mirrored boards or dashboards of the same or other owners.

Boards and widgets may be part of a platform that may enable users to interact with information in real time in collaborative work systems involving electronic collaborative word processing documents. Electronic collaborative word processing documents (and other variations of the term) as used herein are not limited to only digital files for word processing, but may include any other processing document such as presentation slides, tables, databases, graphics, sound files, video files or any other digital document or file. Electronic collaborative word processing documents may include any digital file that may provide for input, editing, formatting, display, and/or output of text, graphics, widgets, objects, tables, links, animations, dynamically updated elements, or any other data object that may be used in conjunction with the digital file. Any information stored on or displayed from an electronic collaborative word processing document may be organized into blocks. A block may include any organizational unit of information in a digital file, such as a single text character, word, sentence, paragraph, page, graphic, or any combination thereof. Blocks may include static or dynamic information, and may be linked to other sources of data for dynamic updates. Blocks may be automatically organized by the system, or may be manually selected by a user according to preference. In one embodiment, a user may select a segment of any information in an electronic word processing document and assign it as a particular block for input, editing, formatting, or any other further configuration.

An electronic collaborative word processing document may be stored in one or more repositories connected to a network accessible by one or more users through their computing devices. In one embodiment, one or more users may simultaneously edit an electronic collaborative word processing document. The one or more users may access the electronic collaborative word processing document through one or more user devices connected to a network. User access to an electronic collaborative word processing document may be managed through permission settings set by an author of the electronic collaborative word processing document. An electronic collaborative word processing document may include graphical user interface elements enabled to support the input, display, and management of multiple edits made by multiple users operating simultaneously within the same document.

Various embodiments are described herein with reference to a system, method, device, or computer readable medium. It is intended that the disclosure of one is a disclosure of all. For example, it is to be understood that disclosure of a computer readable medium described herein also constitutes a disclosure of methods implemented by the computer readable medium, and systems and devices for implementing those methods, via for example, at least one processor. It is to be understood that this form of disclosure is for ease of discussion only, and one or more aspects of one embodiment herein may be combined with one or more aspects of other embodiments herein, within the intended scope of this disclosure.

Embodiments described herein may refer to a non-transitory computer readable medium containing instructions that when executed by at least one processor, cause the at least one processor to perform a method. Non-transitory computer readable mediums may be any medium capable of storing data in any memory in a way that may be read by any computing device with a processor to carry out methods or any other instructions stored in the memory. The non-transitory computer readable medium may be implemented as hardware, firmware, software, or any combination thereof. Moreover, the software may preferably be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine may be implemented on a computer platform having hardware such as one or more central processing units (“CPUs”), a memory, and input/output interfaces. The computer platform may also include an operating system and microinstruction code. The various processes and functions described in this disclosure may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium may be any computer readable medium except for a transitory propagating signal.

As used herein, a non-transitory computer-readable storage medium refers to any type of physical memory on which information or data readable by at least one processor can be stored. Examples of memory include Random Access Memory (RAM), Read-Only Memory (ROM), volatile memory, nonvolatile memory, hard drives, CD ROMs, DVDs, flash drives, disks, any other optical data storage medium, any physical medium with patterns of holes, markers, or other readable elements, a PROM, an EPROM, a FLASH-EPROM or any other flash memory, NVRAM, a cache, a register, any other memory chip or cartridge, and networked versions of the same. The terms “memory” and “computer-readable storage medium” may refer to multiple structures, such as a plurality of memories or computer-readable storage mediums located within an input unit or at a remote location. Additionally, one or more computer-readable storage mediums can be utilized in implementing a computer-implemented method. The memory may include one or more separate storage devices collocated or disbursed, capable of storing data structures, instructions, or any other data. The memory may further include a memory portion containing instructions for the processor to execute. The memory may also be used as a working scratch pad for the processors or as a temporary storage Accordingly, the term computer-readable storage medium should be understood to include tangible items and exclude carrier waves and transient signals.

Some embodiments may involve at least one processor. Consistent with disclosed embodiments, “at least one processor” may constitute any physical device or group of devices having electric circuitry that performs a logic operation on an input or inputs. For example, the at least one processor may include one or more integrated circuits (IC), including application-specific integrated circuit (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. The instructions executed by at least one processor may, for example, be pre-loaded into a memory integrated with or embedded into the controller or may be stored in a separate memory. The memory may include a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the at least one processor may include more than one processor. Each processor may have a similar construction or the processors may be of differing constructions that are electrically connected or disconnected from each other. For example, the processors may be separate circuits or integrated in a single circuit. When more than one processor is used, the processors may be configured to operate independently or collaboratively, and may be co-located or located remotely from each other. The processors may be coupled electrically, magnetically, optically, acoustically, mechanically or by other means that permit them to interact.

Consistent with the present disclosure, disclosed embodiments may involve a network. A network may constitute any type of physical or wireless computer networking arrangement used to exchange data. For example, a network may be the Internet, a private data network, a virtual private network using a public network, a Wi-Fi network, a LAN or WAN network, a combination of one or more of the forgoing, and/or other suitable connections that may enable information exchange among various components of the system. In some embodiments, a network may include one or more physical links used to exchange data, such as Ethernet, coaxial cables, twisted pair cables, fiber optics, or any other suitable physical medium for exchanging data. A network may also include a public switched telephone network (“PSTN”) and/or a wireless cellular network. A network may be a secured network or unsecured network. In other embodiments, one or more components of the system may communicate directly through a dedicated communication network. Direct communications may use any suitable technologies, including, for example, BLUETOOTH™, BLUETOOTH LE™ (BLE), Wi-Fi, near field communications (NFC), or other suitable communication methods that provide a medium for exchanging data and/or information between separate entities.

Certain embodiments disclosed herein may also include a computing device for generating features for work collaborative systems, the computing device may include processing circuitry communicatively connected to a network interface and to a memory, wherein the memory contains instructions that, when executed by the processing circuitry, configure the computing device to receive from a user device associated with a user account instruction to generate a new column of a single data type for a first data structure, wherein the first data structure may be a column oriented data structure, and store, based on the instructions, the new column within the column-oriented data structure repository, wherein the column-oriented data structure repository may be accessible and may be displayed as a display feature to the user and at least a second user account. The computing devices may be devices such as mobile devices, desktops, laptops, tablets, or any other devices capable of processing data. Such computing devices may include a display such as an LED display, augmented reality (AR), virtual reality (VR) display.

Disclosed embodiments may include and/or access a data structure. A data structure consistent with the present disclosure may include any collection of data values and relationships among them. The data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database or NoSQL alternatives for data storage/search such as, for example, MongoDB, Redis, Couchbase, Datastax Enterprise Graph, Elastic Search, Splunk, Solr, Cassandra, Amazon DynamoDB, Scylla, HBase, and Neo4J. A data structure may be a component of the disclosed system or a remote computing component (e.g., a cloud-based data structure). Data in the data structure may be stored in contiguous or non-contiguous memory. Moreover, a data structure, as used herein, does not require information to be co-located. It may be distributed across multiple servers, for example, that may be owned or operated by the same or different entities. Thus, the term “data structure” as used herein in the singular is inclusive of plural data structures.

Certain embodiments disclosed herein may include a processor configured to perform methods that may include triggering an action in response to an input. The input may be from a user action or from a change of information contained in a user's table or board, in another table, across multiple tables, across multiple user devices, or from third-party applications. Triggering may be caused manually, such as through a user action, or may be caused automatically, such as through a logical rule, logical combination rule, or logical templates associated with a board. For example, a trigger may include an input of a data item that is recognized by at least one processor that brings about another action.

In some embodiments, the methods including triggering may cause an alteration of data and may also cause an alteration of display of data contained in a board or in memory. An alteration of data may include a recalculation of data, the addition of data, the subtraction of data, or a rearrangement of information. Further, triggering may also cause a communication to be sent to a user, other individuals, or groups of individuals. The communication may be a notification within the system or may be a notification outside of the system through a contact address such as by email, phone call, text message, video conferencing, or any other third-party communication application.

Some embodiments include one or more of automations, logical rules, logical sentence structures and logical (sentence structure) templates. While these terms are described herein in differing contexts, in a broadest sense, in each instance an automation may include a process that responds to a trigger or condition to produce an outcome; a logical rule may underly the automation in order to implement the automation via a set of instructions; a logical sentence structure is one way for a user to define an automation; and a logical template/logical sentence structure template may be a fill-in-the-blank tool used to construct a logical sentence structure. While all automations may have an underlying logical rule, all automations need not implement that rule through a logical sentence structure. Any other manner of defining a process that respond to a trigger or condition to produce an outcome may be used to construct an automation.

Other terms used throughout this disclosure in differing exemplary contexts may generally share the following common definitions.

In some embodiments, machine learning algorithms (also referred to as machine learning models or artificial intelligence in the present disclosure) may be trained using training examples, for example in the cases described below. Some non-limiting examples of such machine learning algorithms may include classification algorithms, data regressions algorithms, image segmentation algorithms, visual detection algorithms (such as object detectors, face detectors, person detectors, motion detectors, edge detectors, etc.), visual recognition algorithms (such as face recognition, person recognition, object recognition, etc.), speech recognition algorithms, mathematical embedding algorithms, natural language processing algorithms, support vector machines, random forests, nearest neighbors algorithms, deep learning algorithms, artificial neural network algorithms, convolutional neural network algorithms, recursive neural network algorithms, linear machine learning models, non-linear machine learning models, ensemble algorithms, and so forth. For example, a trained machine learning algorithm may comprise an inference model, such as a predictive model, a classification model, a regression model, a clustering model, a segmentation model, an artificial neural network (such as a deep neural network, a convolutional neural network, a recursive neural network, etc.), a random forest, a support vector machine, and so forth. In some examples, the training examples may include example inputs together with the desired outputs corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. In some examples, a machine learning algorithm may have parameters and hyper parameters, where the hyper parameters are set manually by a person or automatically by a process external to the machine learning algorithm (such as a hyper parameter search algorithm), and the parameters of the machine learning algorithm are set by the machine learning algorithm according to the training examples. In some implementations, the hyper-parameters are set according to the training examples and the validation examples, and the parameters are set according to the training examples and the selected hyper-parameters.

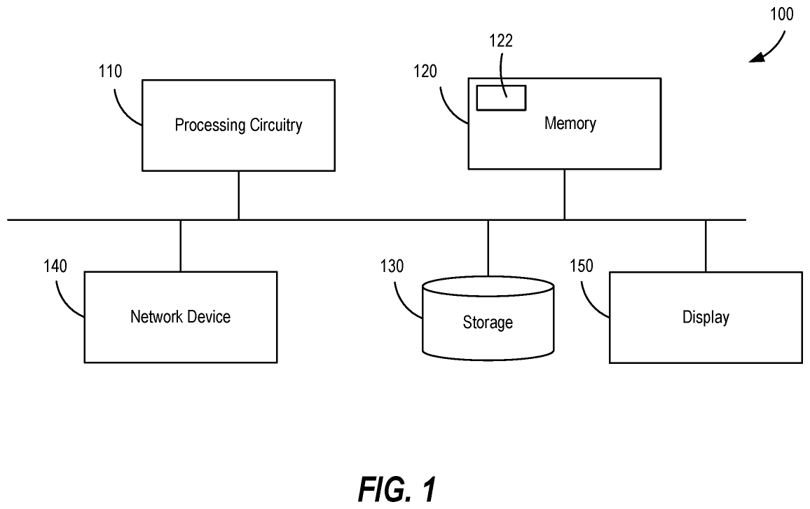

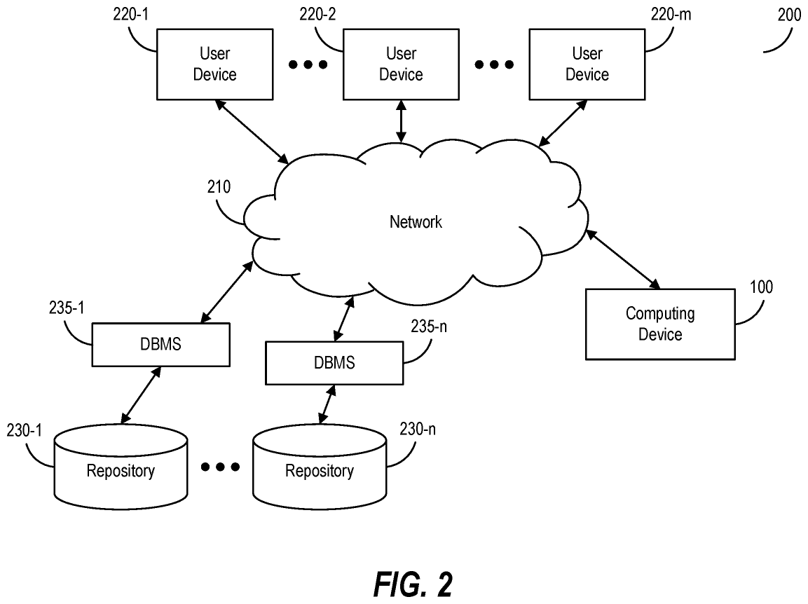

FIG. 1 is a block diagram of an exemplary computing device 100 for performing operations consistent with some embodiments. In some embodiments, computing device 100 may be similar in type and function to user device 220, discussed with respect to FIG. 2. As shown in FIG. 1, computing device 100 may include processing circuitry 110, such as, for example, a central processing unit (CPU). In some embodiments, the processing circuitry 110 may include, or may be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processing circuitry such as processing circuitry 110 may be coupled via a bus 105 to a memory 120.

The memory 120 may further include a memory portion 122 that may contain instructions that when executed by the processing circuitry 110, may perform the method described in more detail herein. The memory 120 may be further used as a working scratch pad for the processing circuitry 110, a temporary storage, and others, as the case may be. The memory 120 may be a volatile memory such as, but not limited to, random access memory (RAM), or non-volatile memory (NVM), such as, but not limited to, flash memory. The processing circuitry 110 may be further connected to a network device 140, such as a network interface card, for providing connectivity between the computing device 100 and a network, such as a network 210, discussed in more detail with respect to FIG. 2 below. The processing circuitry 110 may be further coupled with a storage device 130. The storage device 130 may be used for the purpose of storing single data type column-oriented data structures, data elements associated with the data structures, or any other data structures. While illustrated in FIG. 1 as a single device, it is to be understood that storage device 130 may include multiple devices either collocated or distributed.

The processing circuitry 110 and/or the memory 120 may also include machine-readable media for storing software. “Software” as used herein refers broadly to any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, may cause the processing system to perform the various functions described in further detail herein.

In some embodiments, computing device 100 may include one or more input and output devices (not shown in figure). Computing device may also include a display 150, such as a touchscreen display or other display types discussed herein.

FIG. 2 is a block diagram of computing architecture 200 that may be used in connection with various disclosed embodiments. The computing device 100, as described in connection with FIG. 1, may be coupled to network 210. The network 210 may enable communication between different elements that may be communicatively coupled with the computing device 100, as further described below. The network 210 may include the Internet, the world-wide-web (WWW), a local area network (LAN), a wide area network (WAN), a metro area network (MAN), and other networks capable of enabling communication between the elements of the computing architecture 200. In some disclosed embodiments, the computing device 100 may be a server deployed in a cloud computing environment.

One or more user devices 220-1 through user device 220-m, where ‘m’ in an integer equal to or greater than 1, referred to individually as user device 220 and collectively as user devices 220, may be communicatively coupled with the computing device 100 via the network 210. A user device 220 may be for example, a smart phone, a mobile phone, a laptop, a tablet computer, a wearable computing device, a personal computer (PC), a smart television and the like. A user device 220 may be configured to send to and receive from the computing device 100 data and/or metadata associated with a variety of elements associated with single data type column-oriented data structures, such as columns, rows, cells, schemas, and the like.

One or more data repositories 230-1 through data repository 230-n, where ‘n’ in an integer equal to or greater than 1, referred to individually as data repository 230 and collectively as data repository 230, may be communicatively coupled with the computing device 100 via the network 210, or embedded within the computing device 100. Each data repository 230 may be communicatively connected to the network 210 through one or more database management services (DBMS) 235-1 through DBMS 235-n. The data repository 230 may be for example, a storage device containing a database, a data warehouse, and the like, that may be used for storing data structures, data items, metadata, or any information, as further described below. In some embodiments, one or more of the repositories may be distributed over several physical storage devices, e.g., in a cloud-based computing environment. Any storage device may be a network accessible storage device, or a component of the computing device 100.

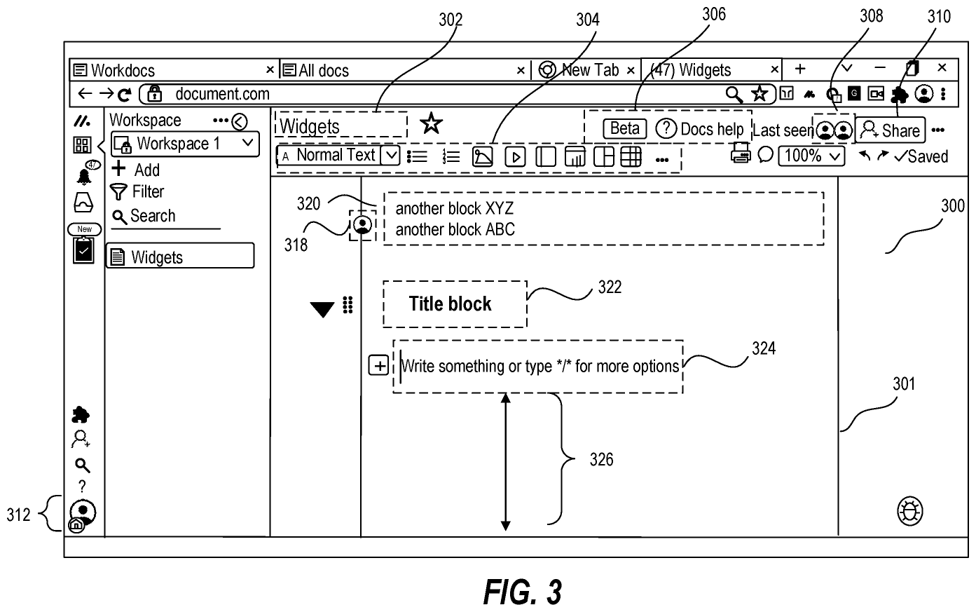

FIG. 3 is an exemplary embodiment of a presentation of an electronic collaborative word processing document 301 via an editing interface or editor 300. In some embodiments, a document 301 and/or editor 300 may be associated with one or more tickets requests, although the disclosed embodiments are not limited to the examples discussed herein. The editor 300 may include any user interface components 302 through 312 to assist with input or modification of information in an electronic collaborative word processing document 301. For example, editor 300 may include an indication of an entity 312, which may include at least one individual or group of individuals associated with an account for accessing the electronic collaborative word processing document. User interface components may provide the ability to format a title 302 of the electronic collaborative word processing document, select a view 304, perform a lookup for additional features 306, view an indication of other entities 308 accessing the electronic collaborative word processing document at a certain time (e.g., at the same time or at a recorded previous time), and configure permission access 310 to the electronic collaborative word processing document. The electronic collaborative word processing document 301 may include information that may be organized into blocks as previously discussed. For example, a block 320 may itself include one or more blocks of information. Each block may have similar or different configurations or formats according to a default or according to user preferences. For example, block 322 may be a “Title Block” configured to include text identifying a title of the document, and may also contain, embed, or otherwise link to metadata associated with the title. A block may be pre-configured to display information in a particular format (e.g., in bold font). Other blocks in the same electronic collaborative word processing document 301, such as compound block 320 or input block 324 may be configured differently from title block 322. As a user inputs information into a block, either via input block 324 or a previously entered block, the platform may provide an indication of the entity 318 responsible for inputting or altering the information. The entity responsible for inputting or altering the information in the electronic collaborative word processing document may include any entity accessing the document, such as an author of the document or any other collaborator who has permission to access the document.

Disclosed embodiments may involve dynamic ticket assignment operations based on continuously changing input and output parameters. The operations may be performed using one or more components of computing device 100 (discussed in FIG. 1) or user device 220 of computing architecture 200 (discussed in FIG. 2). A ticket may be a digital representation of a request. In some embodiments, a ticket may include a file or set of data associated with a request requiring an action by one of more individuals or computer systems. In some embodiments, a request may be made by a requester. In some embodiments, a request may include data associated with an inquiry to perform a task or resolve an issue. For example, a ticket may include one or more of a priority factor, task(s) to be performed, or any other indication of characteristics of an issue to be resolved. A ticket assignment may include one or more of allocating, allotting, distributing, or designating ticket requests among a plurality of entities, or from an entity to another entity such as an available resource. In some embodiments, dynamic ticket assignment may involve the assigning of, or the assigning and reassigning of, ticket requests to available resources at a plurality of time windows. Any number of time windows may be included in the plurality of time window. For example, there may be a first time window, a second time window, a third time window, or any number of time windows. In some embodiments, the plurality of time windows may overlap, and the overlap may be a complete or partial overlap. In other embodiments, the plurality of time windows may occur subsequent to one another.

Some embodiments may initially receive in a backlog data structure from a plurality of different sources, a first plurality of ticket requests. A data structure may include a specialized format for organizing, processing, retrieving, and storing information. For example, a data structure may include a collection of data values, the relationships among them, and the functions or operations that can be applied to the data. Thus, a backlog data structure may include a collection of tasks or requests, the relationships among them, and the functions or operations that can be applied to them.

As used herein, the term “ticket request,” or a ticket, may include a physical or non-physical embodiment of an issue to be resolved. Ticket requests may be created and stored in a plurality of different sources. For example, some ticket requests may be created and stored in a first application or data structure and other ticket requests may be created and stored in a second application or data structure. In some embodiments, ticket requests may be created in one source and stored in a different source.

In some embodiments, each of the first plurality of ticket requests may include first ticket factor information. Ticket factor information may include a priority factor, a skill factor, a language indicator, and a response time factor. The priority factor may include an importance level of the ticket request. For example, the ticket request may be categorized as high importance, neutral importance, or low importance. Thus, a priority factor may include information associated with ranking one request relative to one or more other requests. In some embodiments, a priority factor may be associated with a time period. In such embodiments, the priority factor may be inversely associated with the length of the time period. For example, such a “high priority” request may be one that is associated with a very short time period for completing the request, and a low priority request may be associated with a longer time period. Any number of categories, or importance levels, may be associated with the first priority factor. A skill factor may include the expertise required to resolve the issue associated with the ticket request. In some embodiments, the “skill factor” may be associated with one or more certifications, skill sets, experience levels, a time period of experience, or any other type of metric associated with an ability to address a certain request. Examples of expertise required may include, for example, knowledge or experience in application development, artificial intelligence, cloud computing, HTML, C++, C language, user experience (UX) design, Python, JavaScript, Java, Ruby, finance/accounting, automations, or any other category relevant to addressing an issue to be resolved. A language indicator may include the language required to resolve the issue associated with the ticket request or the language used by the requester. Examples of language include, but are not limited to, English, Mandarin, Hindi, Spanish, French, Arabic, Russian, Portuguese, or any other living or non-living spoken or written manner of communication. A response time factor may include the duration of time allotted to resolve the issue or the duration of time required to resolve the issue. Examples include, but are not limited to, 10 minutes, 30 minutes, 50 minutes, 60 minutes, 1 day, 2 days, or any other duration of time suitable for resolving any particular issue. In some embodiments, the priority factor and the response time factor may be associated. For example, a response time factor of 10 minutes may be associated with a high importance priority factor. As another example, a response time factor of 1 week may be associated with a low importance priority factor. In some embodiments, ticket factor information may further include a descriptive summary of the issue, a date that the ticket was created, a ticket type, a working indicator, or any other relevant details regarding the issue to be resolved.

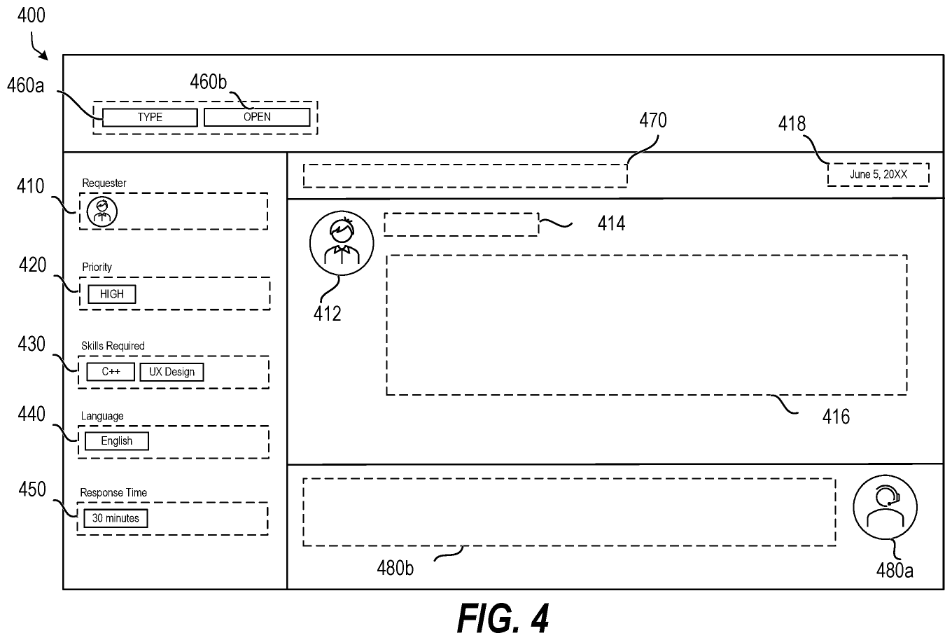

FIG. 4 illustrates an example of a ticket 400, or ticket request, consistent with embodiments of the present disclosure. Ticket 400 may include ticket factor information, such as a requester indication 410, a priority factor 420, one or more skill factors 430, one or more language indicators 440, and a response time factor 450. Requester indication 410 may include details about the requester, or ticket creator, such as an icon 412 or the name 414 of the requester. Priority factor 420 may include the importance level of the ticket, such as high, neutral, or low. As shown in FIG. 4, ticket 400 may have a high importance level. As shown in FIG. 4, skill factors 430 may include C++, UX design, or any other category relevant to addressing the issue to be resolved. Furthermore, language indicator 440 may include English. Response time 450 may include an estimated amount of time it may take the issue associated with ticket 400 to be resolved, such as 30 minutes. Response time 450 may vary depending on the type 460a of ticket. Categories of the type 460a of ticket may include requesting access, resetting passwords, updating data, or any other indicator of a classification of the issue to be resolved.

As shown in FIG. 4, ticket 400 may include a working indicator 460b to provide a status of the ticket, such as an indication that the ticket is currently “open,” being resolved, worked on, or initiated by an available resource. In some embodiments, working indicator 460b may indicate that the ticket is “closed,” indicating that the ticket or issue has been resolved or is inactive for various other reasons. In other embodiments, working indicator 460b may indicate that the ticket is “new,” indicating that the ticket or issue has not been assigned or has not been initiated by an available resource. Working indicator 460b may include any category or indication of the status of a ticket.

In some embodiments, ticket 400 may also include a title 470 of the request. The title 470 may be designated by the requester or a ticket creator. As shown in FIG. 4, ticket 400 may also include a descriptive summary 416 of the issue to be resolved. Furthermore, ticket 400 may include the date 418 that the ticket was created. As indicated by the working indicator 460b, example ticket 400 may be “open” such that ticket 400 has been initiated, or is currently being worked on, by an available resource. In the example of FIG. 4, the assigned available resource may be shown as resource icon 480a. Furthermore, the assigned available resource may provide further detail or description regarding the ticket 400 using resource interface 480b.

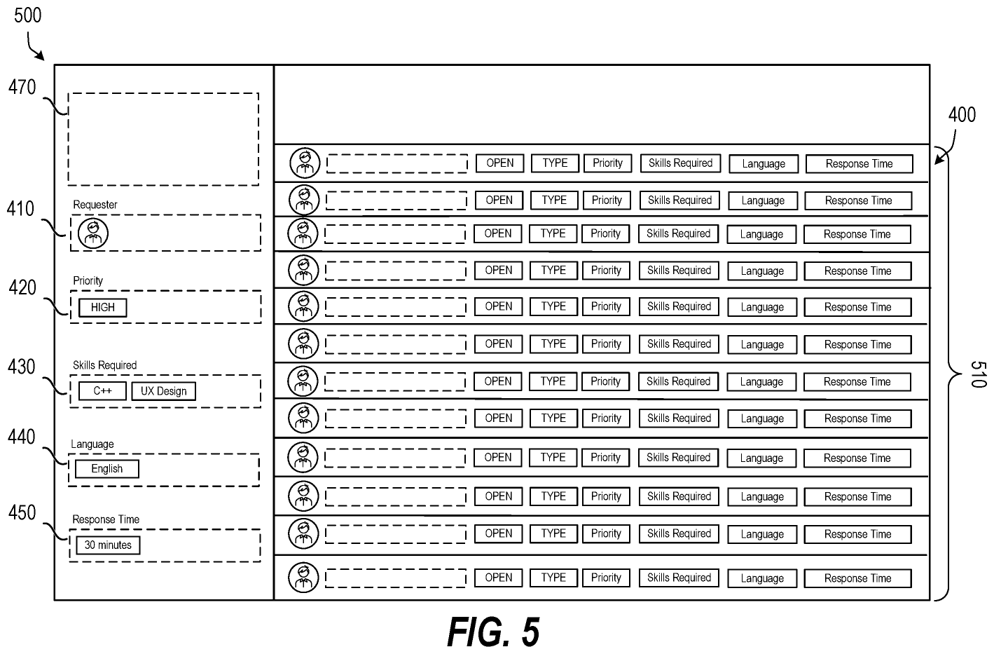

FIG. 5 is an illustration of an exemplary backlog data structure 500 including a plurality of tickets 510, consistent with embodiments of the present disclosure. Backlog data structure 500 may include a collection of tasks or requests, the relationships among them, and the functions or operations that can be applied to them. For example, backlog data structure 500 may include information regarding the plurality of tickets 510. For example, FIG. 5 shows information regarding ticket 400 such as the title 470 of the request, the requester indication 410, the priority factor 420, skill factors 430, language indicators 440, and the response time factor 450. In other embodiments, the backlog data structure may be an electronic collaborative word processing document, such as the example document of FIG. 3.

In some embodiments, at least one processor may receive in a resource availability data structure, resource information about a plurality of available resources. As used herein, an available resource may be associated with an entity such as an individual and/or a computer system. In some embodiments, an available resource may include one or more of an employee, staff member, worker, and personnel capable of assisting in resolving an issue associated with the ticket request. Additionally, or alternatively, the available resource may pertain to a resource that is capable of assisting in resolving an issue and is not necessarily working (or “online”) during the dynamic ticket assignment operations. For example, a particular available resource may be included in the dynamic ticket assignment operations during the working hours of the particular available resource, outside of the working hours of the particular available resource, or both. In some embodiments, resource information for each of the plurality of resources may include resource language information, resource schedule information, resource capacity information, and resource skill information. Resource language information may include the language that the available resource speaks, writes, or understands. Examples of language include, but are not limited to, English, Mandarin, Hindi, Spanish, French, Arabic, Russian, Portuguese, or any other living or non-living spoken or written manner of communication. Resource schedule information may include the working hours of the available resource. For example, a particular available resource may work from 9 am to 5 pm. Thus, the resource schedule information of the particular available resource may include 9 am to 5 pm. As another example, resource schedule information may include vacation days or any other unavailable hours of an available resource. Resource capacity information may include the workload of the available resource. An example of workload of the available resource may include, but is not limited to, the number of ticket requests assigned to the available resource. Resource skill information may include an expertise associated with the available resource. Examples of expertise may include knowledge or experience in application development, artificial intelligence, cloud computing, HTML, C++, C language, UX design, Python, JavaScript, Java, Ruby, or any other category relevant to addressing an issue to be resolved. In some embodiments, resource information may further include an efficiency rating, a projected amount of time it would take the particular available resource to perform a certain task, or any other relevant details regarding the available resource.

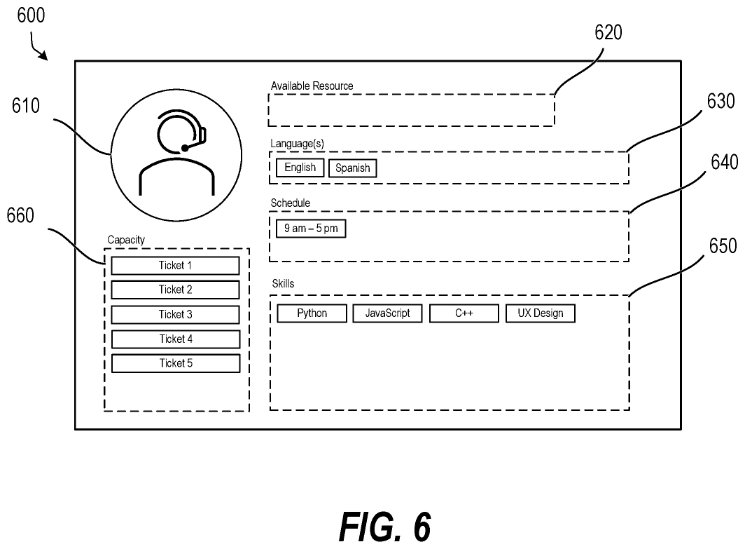

FIG. 6 illustrates an example of resource information 600 of an available resource, consistent with embodiments of the present disclosure. As shown in FIG. 6, resource information 600 may include an icon 610 representing the available resource, a name 620 of the available resource, resource language information 630 regarding languages that the available resource can communicate in, resource schedule information 640 of the available resource, and resource skill information 650 of the available resource. As an example, and as shown in FIG. 6, resource language information 630 may include English and Spanish. Resource schedule information 640 may include 9 am to 5 pm. Resource skill information 650 of the available resource may be any category relevant to addressing an issue to be resolved, such as Python, JavaScript, C++, and UX design. Furthermore, resource capacity information 660 may include the number of tickets assigned to the available resource.

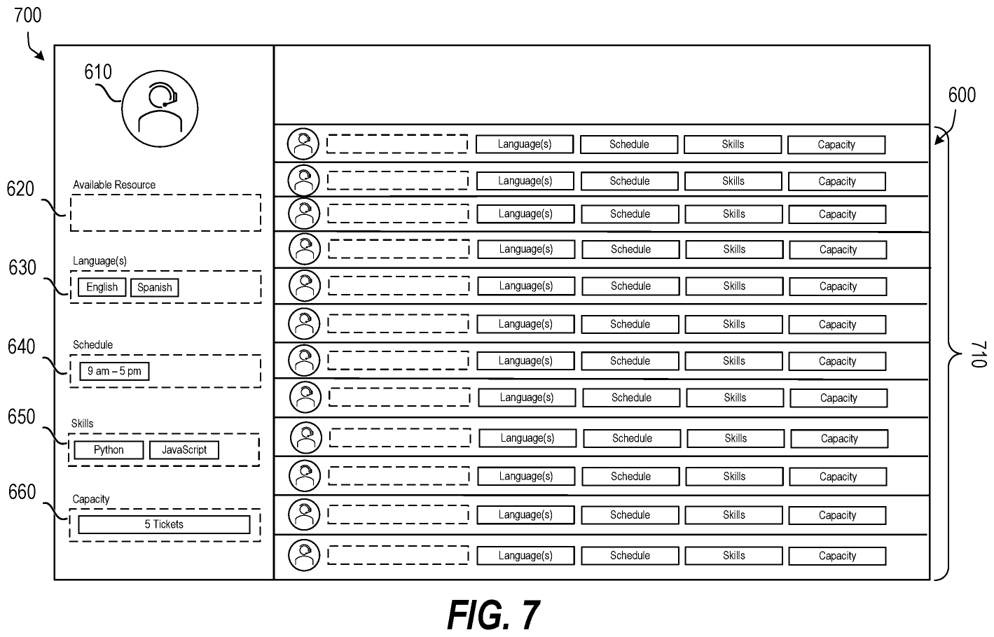

FIG. 7 illustrates an example of a resource availability data structure 700 including a plurality of resource information 710 associated with a plurality of available resources, consistent with embodiments of the present disclosure. Resource availability data structure 700 may include a collection of resource information, the relationships among them, and the functions or operations that can be applied to them. Furthermore, the collection of resource information may be stored in a manner such that resource information associated with a particular available resource is grouped together, as shown in FIG. 7 by the organization of the plurality of resource information 710.

Resource availability data structure 700 may include information regarding the plurality of available resources. For example, FIG. 7 shows information regarding a particular available resource such as the icon 610, name 620, resource language information 630, resource schedule information 640, resource skill information 650, and resource capacity information 660 associated with the particular available resource. In other embodiments, the backlog data structure may be an electronic collaborative word processing document, such as the example document of FIG. 3.

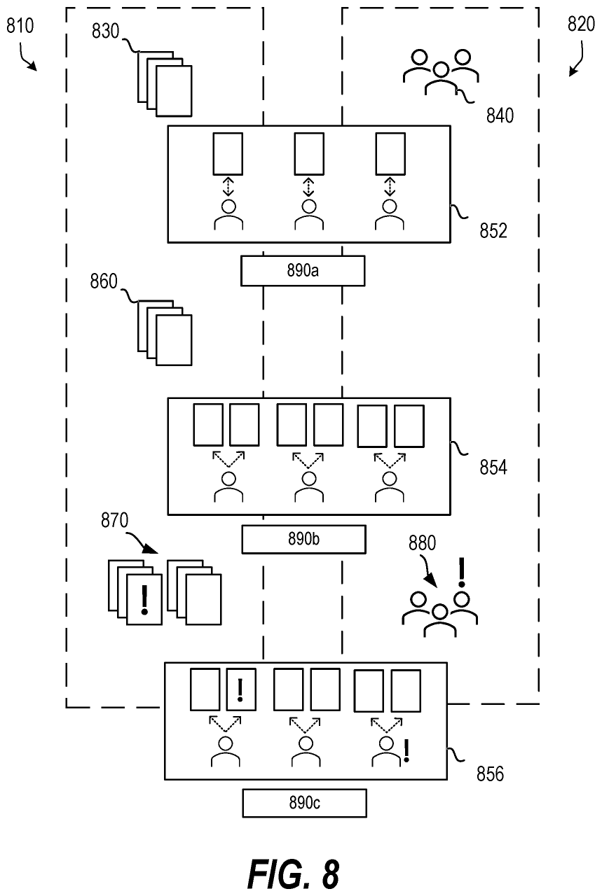

FIG. 8 is a diagram of an exemplary data processing system and technique for performing dynamic ticket assignment operations based on continuously changing input and output parameters, consistent with disclosed embodiments. At least one processor may receive a first plurality of tickets 830 in backlog data structure 810. Resource information about a plurality of available resources 840 may be received in resource availability data structure 820. As shown in FIG. 8, backlog data structure 810 and resource availability data structure 820 may be stored in different locations. In some embodiments, the backlog data structure and the resource availability structure may be stored in a common location.

In some embodiments, at least one processor may, during a first time window following initial receipt of the first plurality of ticket requests, determine a first plurality of preferred matches between the first plurality of ticket requests and the plurality of available resources. The first time window may include one or more of 30 seconds, 1 minute, 2 minutes, 3 minutes, or any other suitable duration of time. In some embodiments, the first time window may occur immediately, or near real time, (e.g., within 30 seconds) after initial receipt of the first plurality of ticket requests. In other embodiments, the first time window may occur a duration of time after (e.g., at least 30 seconds after) initial receipt of the first plurality of ticket requests.

As used herein, a preferred match may include a pairing of a ticket request to an available resource. In some embodiments, the preferred match may be determined based on an optimization of the possible pairings between a plurality of ticket requests a plurality of available resources. For example, the preferred match may be an optimization of the best match between a plurality of ticket requests and a plurality of available resources. The optimization may be determined using one or more of algorithms that use derivatives, direct search and stochastic algorithms (e.g., algorithms designed for objective functions), or suitable machine learning algorithms configured with suitable training data and hyperparameters.

In some embodiments, the preferred match may be determined using one or more stored rules correlating ticket factor information with resource information. The one or more stored rules may include, for example, a first language indicator of the ticket request must have the same value as the resource language information of the available resource, a first time response factor of the ticket request must fall within the resource schedule information of the available resource, a resource capacity information must be below a certain threshold level to be eligible to be paired with a ticket request, and other matching principles that may be used to filter, prioritize, or establish a correlation in the ticket factor information and resource information.

In some embodiments, at least one of the one or more stored rules may be dynamic and change based on a criteria. A criteria may include one or more of the following: an indication to prioritize rules related to language, an indication to prioritize rules related to resource capacity information, and any other higher level rule. In some embodiments, the criteria may be selectable via a user interface. As used herein, a user interface may include a visual display, a graphical user interface (GUI), or any other platform that allows a user to interact with disclosed embodiments. For example, the user interface may be the electronic collaborative word processing document shown in FIG. 3.

In some embodiments, the at least one processor may assign the first plurality of ticket requests based on the first plurality of preferred matches. The assigning, or ticket assignment, may include one or more of allocating, allotting, distributing, or designating ticket requests to one or more available resources. In some embodiments, after assigning the first plurality of ticket requests, one or more of the available resources may begin working on one or more of the assigned ticket requests. Once an available resource begins working on a particular ticket request, the particular ticket request may be considered “initiated” and flagged, or indicated, as “opened.” Ticket requests that have not been worked on by an available resource may be flagged, or indicated, as “unopened.” Additionally, or alternatively, ticket requests that have not been worked on by an available resource may be flagged, or indicated, as “to be re-sorted.”

As shown in FIG. 8, during the first time window 852, each ticket of the first plurality of tickets 830 may be assigned to an available resource of the plurality of available resources 840 based on a preferred match. Each available resource of the plurality of available resources 840 may be matched and assigned a plurality of ticket requests, as shown in FIG. 8. The plurality of ticket requests assigned to an available resource (e.g., a single available resource) may form or be in a queue. In some embodiments, some or all of the first plurality of tickets 830 may be reassigned to an available resource of the plurality of available resources 840 based on an identified potential improvement by, for example, an optimization 890a run by an optimization module. The optimization module and optimization 890a are further discussed below.

In some embodiments, the at least one processor may subsequently receive in the backlog data structure, a second plurality of ticket requests. As used herein, subsequently may include occurring immediately after (e.g., within 30 seconds) an event or occurring after a duration of time has elapsed (e.g., after 30 seconds) after an event. Each of the second plurality of ticket requests may include second ticket factor information. As discussed with respect to the first plurality of ticket requests, ticket factor information may include a priority factor, a skill factor, a language indicator, and a response time factor. The second ticket factor information may include all possible variations of ticket factor information (e.g., priority factor, skill factor, language indicator, and response time factor) as discussed above. As shown in FIG. 8, a second plurality of ticket requests 860 may be received in backlog data structure 810.

In some embodiments, the at least one processor may, during a second time window following subsequent receipt of the second plurality of ticket requests, determine a second plurality of preferred matches between the second plurality of ticket requests and the plurality of available resources. Furthermore, embodiments of the present disclosure may assign the second plurality of ticket requests based on the second plurality of preferred matches. The second time window may include one or more of 30 seconds, 1 minute, 2 minutes, 3 minutes, or any other suitable duration of time. In some embodiments, the second time window may occur immediately (e.g., within 30 seconds) after the first time window. In other embodiments, the second time window may occur a duration of time (e.g., after 30 seconds) after the first time window.

As shown in FIG. 8, each of the second plurality of ticket requests 860 may be assigned to an available resource from the plurality of available resources 840 based on a second plurality of preferred matches, during a second time window 854. Each available resource of the plurality of available resources 840 may be matched and assigned a plurality of ticket requests, as shown in FIG. 8. The plurality of ticket requests assigned to an available resource (e.g., a single available resource) may form or be in a queue. In some embodiments, assignments of the first plurality of tickets 830 and the plurality of available resources 840 made in first time window 852 may remain unchanged. In other embodiments, some or all of the first plurality of tickets 830 and the second plurality of ticket 860 previously assigned may be reassigned to a different available resource of the plurality of available resources 840 based on an identified potential improvement by, for example, an optimization 890b run by an optimization module. The optimization module and optimization 890b are further discussed below.

In some embodiments, the at least one processor may receive in the backlog data structure, updates of ticket factor information for some of the received first and second pluralities of ticket requests. Furthermore, some embodiments may update ticket requests based on the received updates. As used herein, updates may include a change in ticket factor information or new ticket factor information. For example, a change in ticket factor information may include a change in the priority factor. A change in the priority factor may include a change from a low importance level to a high importance level. As another example, new ticket factor information may include an additional language indicator. A ticket request may include English as the language indicator. An additional language indicator, such as Chinese, may be added to the ticket request such that the ticket request includes English and Chinese as language indicators. As yet another example, new ticket factor information may include a descriptive summary of the issue, a date that the ticket was requested, a ticket type, or any other relevant details regarding the issue to be resolved that were not previously provided in the ticket factor information. As shown in FIG. 8, ticket requests 870 may include the one or more updated ticket requests (denoted by an exclamation mark), where updated ticket requests received an update of ticket factor information.

In some embodiments, the at least one processor may receive in the resource availability data structure for at least some plurality of available resources, updates to at least one of the resource schedule information or the resource capacity information. Furthermore, disclosed embodiments may update the resource information based on the received updates. As used herein, updates may further include a change in resource information or new resource information. For example, and as noted above, a change in resource information may include change in at least one of resource schedule information or resource capacity information. As shown in FIG. 8, the plurality of available resource 880 may include the one or more updates to at least one of resource schedule information or resource capacity information of one or more of the available resources (updated resource information is denoted by an exclamation mark associated with an available resource).

A change in resource schedule information may include a change in the working hours of an available resource. For example, the resource schedule information of a particular available resource may be 9 am to 5 pm. An update to the resource schedule information may include a change of the resource schedule information of the particular available resource to be 7 am to 3 pm. As another example, an update to the resource schedule information may include a change of the resource schedule information of the particular available resource to reflect, for example, vacation days.

A change in resource capacity information may include a change in the workload of the available resource. For example, the resource capacity information of a particular available resource may include five tickets. An update to the resource capacity information may include a change of the resource capacity information of the particular available resource to be two tickets.

As another example, new resource information may include an efficiency rating, a projected amount of time it would take the available resource to perform a certain task, or any other relevant details regarding the available resource that were not previously provided in the resource information.

In some embodiments, the at least one processor may, during a third time window following the second time window, determine a third plurality of preferred matches between: at least one of the first ticket requests, the second ticket requests, or the updated ticket requests; and at least one of the available resources or the updated available resource. Furthermore, some embodiments may assign at least one of the first ticket requests, second ticket requests, or the updated ticket requests, based on the third plurality of preferred matches. The third time window may include one or more of 30 seconds, 1 minute, 2 minutes, 3 minutes, or any other suitable duration of time. In some embodiments, the third time window may occur immediately (e.g., within 30 seconds) after one or more of the first time window and the second time window. In other embodiments, the third time window may occur a duration of time (e.g., after 30 seconds) after one or more of the first time window and the second time window.

As shown in FIG. 8, during third time window 856, at least one of the plurality of ticket requests 870 may be assigned to one of the plurality of available resource 880 based on the third plurality of preferred matches. Each available resource of the plurality of available resources 880 may be matched and assigned a plurality of ticket requests, as shown in FIG. 8. The plurality of ticket requests assigned to an available resource (e.g., a single available resource) may form or be in a queue. In some embodiments, some or all of the plurality of ticket requests 870 previously assigned may be reassigned to a different available resource of the plurality of available resources 880 based on an identified potential improvement by, for example, an optimization 890c run by an optimization module. The optimization module and optimization 890c are further discussed below.

In some embodiments, the at least one processor may run an optimization on one or more assigned ticket requests to identify a potential improvement. Additionally, or alternatively, embodiments of the present disclosure may reassign at least one previously assigned ticket request of the one or more assigned ticket requests based on the identified potential improvement. Furthermore, in some embodiments, previously assigned tickets already initiated may be excluded from the optimization. In other embodiments, previously assigned tickets already initiated may be included in the optimization. For example, if an available resource has initiated the previously assigned ticket but has not completed the previously assigned ticket or resolved the issue within a particular duration of time, the previously assigned ticket may be included in the optimization. As used herein, tickets already initiated may include tickets that have been or are currently being worked on by an available resource. Tickets already initiated may, in some embodiments, be referred to as “open” tickets.

For example, in some embodiments, and as shown in FIG. 8, an optimization 890a, 890b, and 890c may be performed, executed, or run, at one or more predetermined intervals on one or more of assigned tickets. As mentioned previously with respect to FIG. 4, tickets such as ticket 400 may include a working indicator 460b that indicates whether the ticket has been initiated, started, or worked on by an available resource. One or more of tickets in the plurality of tickets 830, 860, and 870 may include working indicator 460b. Thus, the one or more tickets in the plurality of tickets 830, 860, and 870 with working indicators that indicate that the tickets have been initiated may be flagged and removed from consideration during optimization 890a, 890b, and 890c.

Optimization 890a, 890b, and 890c may be performed by an optimizer module. The optimizer module may be a physical structure with specialized integrated circuits, or a code module executed by one or more processors. In some embodiments, the optimizer module may operate at predetermined intervals, such as, but not limited to, every 30 minutes or every hour. At each predetermined interval (e.g., every 30 minutes), the optimizer module may be configured to assess all assigned tickets to determine if a better plurality of preferred matches and assignments is possible compared to the assignments of tickets 890a, 890b, and 890c. In other embodiments, the optimizer module may operate when new information or tickets are received, when resource information of one or more available resources are updated, or when triggered by an external indication. Additionally, or alternatively, the optimizer module may provide rules or criteria that are used in the determining of one or more of the plurality of preferred matches.

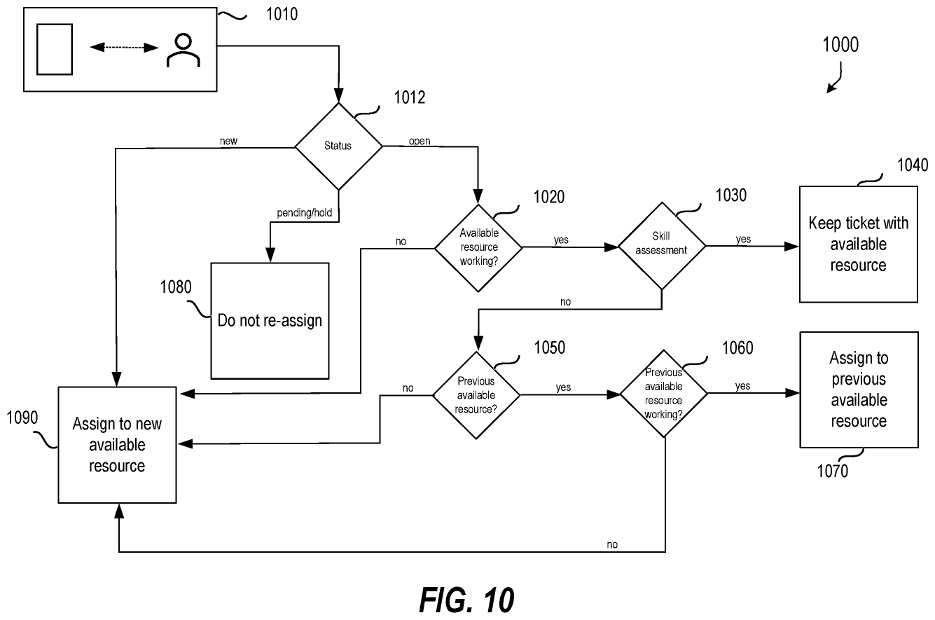

FIG. 10 is a flowchart of an example of optimization 1000 of performing dynamic ticket assignment operations, consistent with disclosed embodiments. As shown in FIG. 10, a ticket may be assigned to an available resource, as shown in step 1010. The status 1012 of the ticket may be assessed, where the status may include “open,” “new,” or “pending/hold.” An “open” status may pertain to a ticket that is has been worked on, but not yet resolved, by the available resource. A “new” status may pertain to a ticket that has been assigned but has not been worked on by the available resource. A “pending/hold” status may pertain to a ticket that is to not be included in a re-assigning or optimization operation or process.

As shown in FIG. 10, a ticket with an “open” status may undergo a first assessment 1020 based on whether the available resource is working (e.g., based on resource schedule information). If the result of the first assessment 1020 is no, the ticket may be designated for assignment 1090 to a new available resource. If the result of the first assessment 1020 is yes, the ticket and available resource may undergo a second assessment 1030 to ensure the skill information of the available resource matches or corresponds with a skill factor of the ticket. If the result of the second assessment 1030 is yes, the ticket may remain assigned to the available resource 1040. If the result of the second assessment 1040 is no, the ticket may undergo a third assessment 1050 to assess if the ticket was previously assigned to a second available resource. If the result of the third assessment 1050 is no, the ticket may be designated for assignment 1090 to a new available resource. If the result of the third assessment 1050 is yes, the second available resource may undergo a fourth assessment 1060 based on whether the second available resource is working (e.g., based on resource schedule information). If the result of the fourth assessment 1060 is yes, the ticket may be re-assigned to the second available resource 1070. If the result of the fourth assessment 1060 is no, the ticket may be designated for assignment 1090 to a new available resource.

As shown in FIG. 10, a ticket with a “pending/hold” status may not be re-assigned 1080. Furthermore, as shown in FIG. 10, a ticket with a “new” status may be designated for assignment 1090 to a new available resource.

As an example, a ticket 400 may be assigned to a particular available resource. The optimizer module may operate every 30 minutes. The optimizer module may consider that ticket 400 has been assigned to the particular available resource, but the resource schedule information 640 associated with the particular available resource may indicate that the particular available resource will no longer be working in 20 minutes. The optimizer module may flag, tag, or otherwise mark ticket 400 as a ticket to be reassigned or re-sorted. Ticket 400 may then be introduced as a new ticket, such as with the plurality of tickets 830 or 860, and assigned to a different available resource based on a preferred match. In some embodiments, re-assigned ticket 400 may include a “high priority factor” such that it, for example, is worked on by an available resource and resolved before the new tickets of the plurality of tickets 830 or 860.

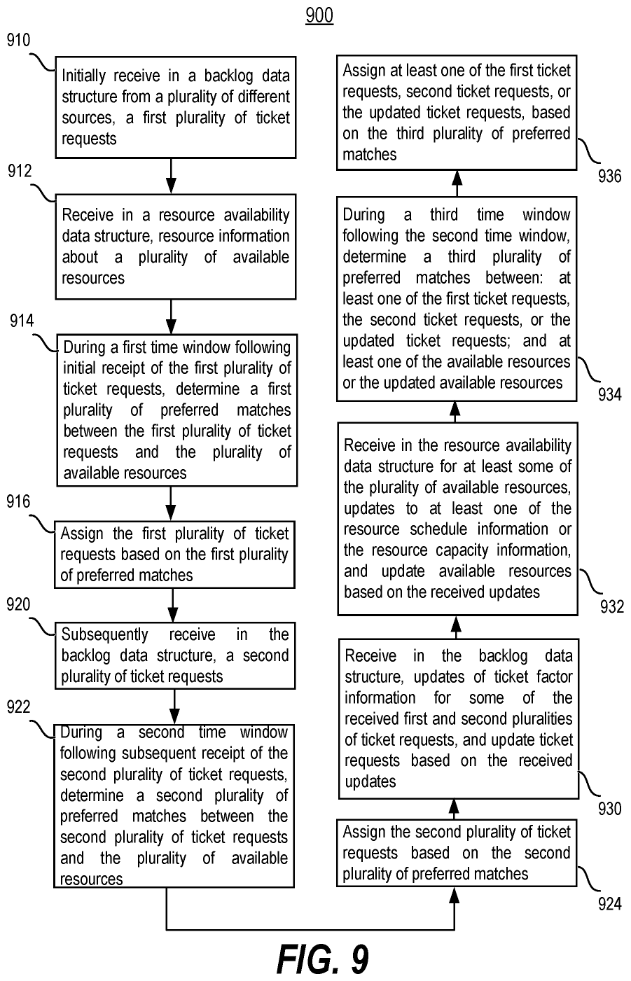

FIG. 9 illustrates a flowchart for performing dynamic ticket assignment operations 900, consistent with embodiments of the present disclosure. As shown in step 910, in some embodiments, at least one processor may initially receive in a backlog data structure from a plurality of different sources, a first plurality of ticket requests. Disclosed embodiments may then receive in a resource availability data structure, resource information about a plurality of available resource, as shown in step 912. Some embodiments, and as shown in step 914, during a first time window following initial receipt of the first plurality of ticket requests, may determine a first plurality of preferred matches between the first plurality of ticket requests and the plurality of available resource. As shown in step 916, disclosed embodiments may assign the first plurality of ticket requests based on the first plurality of preferred matches.

In some embodiments, the at least one processor may subsequently receive in the backlog data structure, a second plurality of ticket requests, as shown in step 920. For example, as shown in step 922, during a second time window following subsequent receipt of the second plurality of ticket requests, at least one processor may determine a second plurality of preferred matches between the second plurality of ticket requests and the plurality of available resources. As shown in step 924, embodiments of the present disclosure may assign the second plurality of ticket requests based on the second plurality of preferred matches.

As shown in step 930 of FIG. 9, some embodiments may receive in the backlog data structure, updates of ticket factor information for some of the received first and second pluralities of ticket requests, and update ticket requests based on the received updates. Disclosed embodiments may receive in the resource availability data structure for at least some of the plurality of available resources, updates to at least one of the resource schedule information or the resource capacity information, and update the resource information based on the received updates, as shown in step 932. As shown in step 934, during a third time window following the second time window, disclosed embodiments may determine a third plurality of preferred matches between: at least one of the first ticket requests, the second ticket requests, or the updated ticket requests; and at least one of the available resources or the updated available resources. Furthermore, as shown in step 936, embodiments of the present disclosure may assign at least one of the first ticket requests, second ticket requests, or the updated ticket requests, based on the first plurality of preferred matches.

Unless otherwise defined, all technical and scientific terms used herein have the same meaning as commonly understood by one of ordinary skill in the art. The materials, methods, and examples provided herein are illustrative only and not intended to be limiting.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a chip or a circuit. As software or algorithm, selected steps of the disclosure could be implemented as a plurality of software instructions being executed by a computer using any suitable operating system. In any case, selected steps of the method and system of the disclosure could be described as being performed by a data processor, such as a computing device for executing a plurality of instructions.

As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Although the present disclosure is described with regard to a “computing device”, a “computer”, or “mobile device”, it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may optionally comprise a “network” or a “computer network”.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment or implementation are necessary in every embodiment or implementation of the invention. Further combinations of the above features and implementations are also considered to be within the scope of some embodiments or implementations of the invention.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

Disclosed embodiments may include any one of the following elements alone or in combination with one or more other elements, whether implemented as a method, by at least one processor, and/or stored as executable instructions on non-transitory computer-readable media: A system for performing dynamic ticket assignments based on continuously changing input and output parameters. The system may include at least one processor configured to: initially receive in a backlog data structure from a plurality of different sources, a first plurality of ticket requests wherein each of the first plurality of ticket requests includes first ticket factor information, the first ticket factor information including a first priority factor, a first skill factor, a first language indicator, and a first response time factor. The at least one processor may receive in a resource availability data structure, resource information about a plurality of available resources, wherein the resource information for each of the plurality of resources includes resource language information, resource schedule information, resource capacity information, and resource skill information. During a first time window following initial receipt of the first plurality of ticket requests, the at least one processor may determine a first plurality of preferred matches between the first plurality of ticket requests and the plurality of available resources, and assign the first plurality of ticket requests based on the first plurality of preferred matches. The at least one processor may subsequently receive in the backlog data structure, a second plurality of ticket requests, wherein each of the second plurality of ticket requests includes second ticket factor information, the second ticket factor including a second priority factor, a second skill factor, a second language indicator, and a second response time factor. During a second time window following subsequent receipt of the second plurality of ticket requests, the at least one processor may determine a second plurality of preferred matches between the second plurality of ticket requests and the plurality of available resources, assign the second plurality of ticket requests based on the second plurality of preferred matches, receive in the backlog data structure, updates of ticket factor information for some of the received first and second pluralities of ticket requests, and update ticket requests based on the received updates, receive in the resource availability data structure for at least some plurality of availability resources, updates to at least one of the resource schedule information or the resource capacity information, and update the resource information based on the received updates. During a third time window following the second time window, the at least one processor may determine a third plurality of preferred matches between: at least one of the first ticket requests, the second ticket requests, or the updated ticket requests; and at least one of the available resources or the updated available resources. The at least one processor may assign at least one of the first ticket requests, second ticket requests, or the updated ticket requests, based on the third plurality of preferred matches, wherein at least one of the first, second, or third plurality of preferred matches are determined using one or more stored rules correlating ticket factor information with resource information, and wherein at least one of the stored rules is dynamic and changes based on a criteria. The at least one processor may run an optimization on at least one unassigned ticket request and at least one assigned ticket request to identify a potential improvement, and reassign at least one previously assigned ticket request based on the identified potential improvement

Systems and methods disclosed herein involve unconventional improvements over conventional approaches. Descriptions of the disclosed embodiments are not exhaustive and are not limited to the precise forms or embodiments disclosed. Modifications and adaptations of the embodiments will be apparent from consideration of the specification and practice of the disclosed embodiments. Additionally, the disclosed embodiments are not limited to the examples discussed herein.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure may be implemented as hardware alone.

It is appreciated that the above described embodiments can be implemented by hardware, or software (program codes), or a combination of hardware and software. If implemented by software, it can be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above described modules/units can be combined as one module or unit, and each of the above described modules/units can be further divided into a plurality of sub-modules or sub-units.

The block diagrams in the figures illustrate the architecture, functionality, and operation of possible implementations of systems, methods, and computer hardware or software products according to various example embodiments of the present disclosure. In this regard, each block in a flowchart or block diagram may represent a module, segment, or portion of code, which includes one or more executable instructions for implementing the specified logical functions. It should be understood that in some alternative implementations, functions indicated in a block may occur out of order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as example only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

It will be appreciated that the embodiments of the present disclosure are not limited to the exact construction that has been described above and illustrated in the accompanying drawings, and that various modifications and changes may be made without departing from the scope thereof.

Other embodiments will be apparent to those skilled in the art from consideration of the specification and practice of the disclosed embodiments disclosed herein. It is intended that the specification and examples be considered as exemplary only, with a true scope and spirit of the disclosed embodiments being indicated by the following claims.

Computer programs based on the written description and methods of this specification are within the skill of a software developer. The various programs or program modules can be created using a variety of programming techniques. One or more of such software sections or modules can be integrated into a computer system, non-transitory computer readable media, or existing software.

This disclosure employs open-ended permissive language, indicating for example, that some embodiments “may” employ, involve, or include specific features. The use of the term “may” and other open-ended terminology is intended to indicate that although not every embodiment may employ the specific disclosed feature, at least one embodiment employs the specific disclosed feature.

Various terms used in the specification and claims may be defined or summarized differently when discussed in connection with differing disclosed embodiments. It is to be understood that the definitions, summaries and explanations of terminology in each instance apply to all instances, even when not repeated, unless the transitive definition, explanation or summary would result in inoperability of an embodiment.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application. These examples are to be construed as non-exclusive. Further, the steps of the disclosed methods can be modified in any manner, including by reordering steps or inserting or deleting steps. It is intended, therefore, that the specification and examples be considered as exemplary only, with a true scope and spirit being indicated by the following claims and their full scope of equivalents.

1. A non-transitory computer readable medium containing instructions that when executed by the at least one processor cause the at least one processor to perform dynamic ticket assignment operations based on continuously changing input and output parameters, the operations comprising:
initially receiving in a backlog data structure from a plurality of different sources, a first plurality of ticket requests, wherein each of the first plurality of ticket requests includes first ticket factor information including a first priority factor, a first skill factor, a first language indicator, and a first response time factor;
receiving in a resource availability data structure, resource information about a plurality of available resources, wherein the resource information for each of the plurality of resources includes resource language information, resource schedule information, resource capacity information, and resource skill information;
during a first time window following initial receipt of the first plurality of ticket requests, determining, using a machine learning algorithm, a first plurality of preferred matches between the first plurality of ticket requests and the plurality of available resources;
assigning the first plurality of ticket requests based on the first plurality of preferred matches;
subsequently receiving in the backlog data structure, a second plurality of ticket requests, wherein each of the second plurality of ticket requests includes second ticket factor information including a second priority factor, a second skill factor, a second language indicator, and a second response time factor;
during a second time window following subsequent receipt of the second plurality of ticket requests, determining, using the machine learning algorithm, a second plurality of preferred matches between the second plurality of ticket requests and the plurality of available resources;
assigning the second plurality of ticket requests based on the second plurality of preferred matches;
generating a graphical user interface for displaying the first plurality of ticket requests and the second plurality of ticket requests with corresponding indicators representing their statuses based on the first ticket factor information and the second ticket factor information;
receiving in the backlog data structure, updates of ticket factor information for some of the received first and second pluralities of ticket requests, and updating ticket requests based on the received updates;
receiving in the resource availability data structure for at least some plurality of available resources, updates to at least one of the resource schedule information or the resource capacity information, and updating the resource information based on the received updates;
during a third time window following the second time window, determining, using the machine learning algorithm, a third plurality of preferred matches between: at least one of the first plurality of ticket requests, the second plurality of ticket requests, or the updated ticket requests; and at least one of the available resources or the updated available resource;
reassigning at least one of the first ticket requests, second ticket requests, or the updated ticket requests, based on the third plurality of preferred matches, wherein the third plurality of preferred matches includes a match between a particular ticket request among the updated ticket requests and a previously available resource that had been previously assigned to a different ticket request;
updating the indicators of the graphical user interface corresponding to ticket requests matched in the third plurality of preferred matches; and
pushing the graphical user interface with the updated indicators to a network of user devices.

2. The non-transitory computer readable medium of claim 1, wherein at least one of the first, second, or third plurality of preferred matches are determined using one or more stored rules correlating ticket factor information with resource information.

3. The non-transitory computer readable medium of claim 2, wherein at least one of the stored rules is dynamic and changes based on a criteria.

4. The non-transitory computer readable medium of claim 3, wherein the criteria is selectable via a user interface.

5. The non-transitory computer readable medium of claim 1, wherein at least one of the first plurality of preferred matches, the second plurality of preferred matches, or the third plurality of preferred matches is an optimization of the best match between ticket requests and available resources.

6. The non-transitory computer readable medium of claim 1, the operations further comprising running an optimization on one or more assigned ticket requests to identify a potential improvement.

7. The non-transitory computer readable medium of claim 6, the operations further comprising reassigning at least one previously assigned ticket request of the one or more assigned ticket requests based on the identified potential improvement.

8. The non-transitory computer readable medium of claim 6, wherein previously assigned tickets already initiated are excluded from the optimization.

9. The non-transitory computer readable medium of claim 1, wherein the backlog data structure and resource availability data structure are stored in a common location.

10. The non-transitory computer readable medium of claim 1, wherein the backlog data structure and resource data structure are stored in different locations.

11. A method for performing dynamic ticket assignments based on continuously changing input and output parameters, the method comprising:
initially receiving in a backlog data structure from a plurality of different sources, a first plurality of ticket requests, wherein each of the first plurality of ticket requests includes first ticket factor information including a first priority factor, a first skill factor, a first language indicator, and a first response time factor;
receiving in a resource availability data structure, resource information about a plurality of available resources, wherein the resource information for each of the plurality of resources includes resource language information, resource schedule information, resource capacity information, and resource skill information;
during a first time window following initial receipt of the first plurality of ticket requests, determining, using a machine learning algorithm, a first plurality of preferred matches between the first plurality of ticket requests and the plurality of available resources;
assigning the first plurality of ticket requests based on the first plurality of preferred matches;
subsequently receiving in the backlog data structure, a second plurality of ticket requests, wherein each of the second plurality of ticket requests includes second ticket factor information including a second priority factor, a second skill factor, a second language indicator, and a second response time factor;
during a second time window following subsequent receipt of the second plurality of ticket requests, determining, using the machine learning algorithm, a second plurality of preferred matches between the second plurality of ticket requests and the plurality of available resources;
assigning the second plurality of ticket requests based on the second plurality of preferred matches;
generating a graphical user interface for displaying the first plurality of ticket requests and the second plurality of ticket requests with corresponding indicators representing their statuses based on the first ticket factor information and the second ticket factor information;
receiving in the backlog data structure, updates of ticket factor information for some of the received first and second pluralities of ticket requests, and update ticket requests based on the received updates;
receiving in the resource availability data structure for at least some plurality of available resources, updates to at least one of the resource schedule information or the resource capacity information, and update available resources based on the received updates;
during a third time window following the second time window, determining, using the machine learning algorithm, a third plurality of preferred matches between at least one of the first ticket requests, the second ticket requests, or the updated ticket requests; and at least one of the available resources or the updated available resources;
reassigning at least one of the first ticket requests, second ticket requests, or the updated ticket requests, based on the third plurality of preferred matches, wherein the third plurality of preferred matches includes a match between a particular ticket request among the updated ticket requests and a previously available resource that had been previously assigned to a different ticket request;
updating the indicators of the graphical user interface corresponding to ticket requests matched in the third plurality of preferred matches; and
pushing the graphical user interface with the updated indicators to a network of user devices.

12. The method of claim 11, wherein at least one of the first, second, or third plurality of preferred matches are determined using one or more stored rules correlating ticket factor information with resource information.

13. The method of claim 12, wherein at least one of the stored rules is dynamic and changes based on a criteria.

14. The method of claim 11, further comprising running an optimization on at least one unassigned ticket request and at least one assigned ticket request to identify a potential improvement.

15. The method of claim 14, further comprising reassigning at least one previously assigned ticket request based on the identified potential improvement.

16. A system for performing dynamic ticket assignments based on continuously changing input and output parameters, the system comprising:
at least one processor configured to:
initially receive in a backlog data structure from a plurality of different sources, a first plurality of ticket requests, wherein each of the first plurality of ticket requests includes first ticket factor information including a first priority factor, a first skill factor, a first language indicator, and a first response time factor;
receive in a resource availability data structure, resource information about a plurality of available resources, wherein the resource information for each of the plurality of resources includes resource language information, resource schedule information, resource capacity information, and resource skill information;
during a first time window following initial receipt of the first plurality of ticket requests, determine, using a machine learning algorithm, a first plurality of preferred matches between the first plurality of ticket requests and the plurality of available resources;
assign the first plurality of ticket requests based on the first plurality of preferred matches;
subsequently receive in the backlog data structure, a second plurality of ticket requests, wherein each of the second plurality of ticket requests includes second ticket factor information including a second priority factor, a second skill factor, a second language indicator, and a second response time factor;
during a second time window following subsequent receipt of the second plurality of ticket requests, determine, using the machine learning algorithm, a second plurality of preferred matches between the second plurality of ticket requests and the plurality of available resources;
assign the second plurality of ticket requests based on the second plurality of preferred matches;
generating a graphical user interface for displaying the first plurality of ticket requests and the second plurality of ticket requests with corresponding indicators representing their statuses based on the first ticket factor information and the second ticket factor information;
receive in the backlog data structure, updates of ticket factor information for some of the received first and second pluralities of ticket requests, and update ticket requests based on the received updates;
receive in the resource availability data structure for at least some plurality of available resources, updates to at least one of the resource schedule information or the resource capacity information, and update available resources based on the received updates;
during a third time window following the second time window, determine, using the machine learning algorithm, a third plurality of preferred matches between at least one of the first ticket requests, the second ticket requests, or the updated ticket requests; and at least one of the available resources or the updated available resources;
reassign at least one of the first ticket requests, second ticket requests, or the updated ticket requests, based on the third plurality of preferred matches, wherein the third plurality of preferred matches includes a match between a particular ticket request among the updated ticket requests and a previously available resource that had been previously assigned to a different ticket request;
updating the indicators of the graphical user interface corresponding to ticket requests matched in the third plurality of preferred matches; and
pushing the graphical user interface with the updated indicators to a network of user devices.

17. The system of claim 16, wherein at least one of the first, second, or third plurality of preferred matches are determined using one or more stored rules correlating ticket factor information with resource information.

18. The system of claim 17, wherein at least one of the stored rules is dynamic and changes based on a criteria.

19. The system of claim 16, wherein the at least one processor is further configured to run an optimization on at least one unassigned ticket request and at least one assigned ticket request to identify a potential improvement.

20. The system of claim 19, wherein the at least one processor is further configured to reassign at least one previously assigned ticket request based on the identified potential improvement.

21. The non-transitory computer readable medium of claim 1, wherein the determining the third plurality of preferred matches comprises considering the first priority factor or the second priority factor over other information included in the ticket factor information.

22. The non-transitory computer readable medium of claim 1, wherein the first plurality of preferred matches is determined for each of the first plurality of ticket requests during the first time window, and wherein the second plurality of preferred matches is determined for each of the second plurality of ticket requests during the second time window.

23. The non-transitory computer readable medium of claim 1, wherein the indicators of the graphical user interface further represent shift information of the plurality of available resources.

24. The non-transitory computer readable medium of claim 1, wherein:
the updates of ticket factor information include a change in the first priority factor or the second priority factor, and
the third plurality of preferred matches are determined for the updated ticket requests with higher priority factors before the third plurality of preferred matches are determined for the first plurality of ticket requests, the second plurality ticket requests, or the updated ticket requests with lower priority factors.

25. The non-transitory computer readable medium of claim 5, wherein the optimization of the best match between ticket requests and available resources is performed by an optimizer module.

26. The non-transitory computer readable medium of claim 25, wherein the optimizer module performs the optimization at predetermined intervals.

27. The non-transitory computer readable medium of claim 5, wherein the optimization of the best match between ticket requests and available resources involves assessing a status of each of the ticket requests and resource schedule information of each of the available resources.
